(19) United States
(12) Patent Application Publication
(10) Pub. No.: US 2016/0020617 A1
(43) Pub. Date: Jan. 21, 2016

(54) ELECTRONIC CHARGING DEVICE

(71) Applicants: Marty GOLDBERG, Camarillo, CA (US); Jack DING, Camarillo, CA (US)

(72) Inventors: Marty GOLDBERG, Camarillo, CA (US); Jack DING, Camarillo, CA (US)

(73) Assignee: Lenmar Enterprises Inc., Camarillo, CA (US)

(21) Appl. No.: 14/334,659

(22) Filed: Jul. 17, 2014

(51) Int. Cl. H02J 7/00; H02J 7/04; H02J 7/02

(52) U.S. Cl. CPC H02J 7/007; H02J 7/0029; H02J 7/0052; H02J 7/022; H02J 7/04; H02J 2007/0037; H02J 2007/0059

(57) ABSTRACT

Disclosed is a portable rechargeable device which accepts alternating current as an input, stores the power internally in a DC battery, and then provides alternating current output power. The device is designed to accommodate virtually all portable electronic devices such as iPhones®, other cell phones, iPads®, other tablets, MacBooks® and other portable computers.

### BACKGROUND OF THE INVENTION

1. Field of the Invention

The invention relates to devices used for charging portable electronic equipment. More specifically, the invention relates to portable devices used for charging electronic equipment.

2. Description of the Related Art

In the past, charging devices for portable electronic equipment, notably cell phones and portable PCs and tablets, have been limited to a so-called power supply which at its input receives 110 or 220 V alternating current, and at its output provides 3, 6, or 12 volts or other level DC current for powering the device.

Such devices did not store energy, but merely converted the energy from alternating current to direct-current.

### BRIEF SUMMARY OF THE INVENTION

In the past, users of portable electronic devices suffered from the scarcity of power supplies for recharging their devices while they were away from their home or office. Most notably, even at modern international airports throughout the world, there is an acute paucity of areas for recharging portable devices. It is a familiar sight to see many people sitting on the floor of the airport terminal crowded around one or two power supply outlets which are located at the base of a column or hidden behind chairs in the waiting areas, while needy customers eye the few outlets for the moment one becomes available, so they too have the privilege of sitting on the dirty terminal floor recharging their electronic device. Virtually every passenger in an airport terminal has at least one electronic device which is meanwhile constantly discharging. In some cases there are many thousands of needy customers for each power outlet available. The exception would be for the elite group of travelers who have access to the lounge areas. However, even in the lounge areas, there is a scarcity of outlets.

Once in the plane, again, there is a shortage of power supply outlets for recharging devices, although many passengers are literally using their electronic devices for the entire flight.

This problem repeats itself in other areas other than airports, such as in trains, automobiles, and other waiting areas.

It is therefore an object of the invention to provide a solution to the problem of charging electronic devices while away from the home or office.

It is another object of invention to provide a portable power supply which will allow electronic portable electronic device users to recharge their devices without the need for an electric outlet fixed to a building or present in an airplane or train.

It is a further object of invention to provide a portable charging device which accepts 110 V or 220 V as an input at one end of the device, stores the power internally, and then releases the power in the form of 110 V or 220 V to a plug-in power supply at the other end of the device.

### BRIEF DESCRIPTION OF THE SEVERAL VIEWS OF THE INVENTION

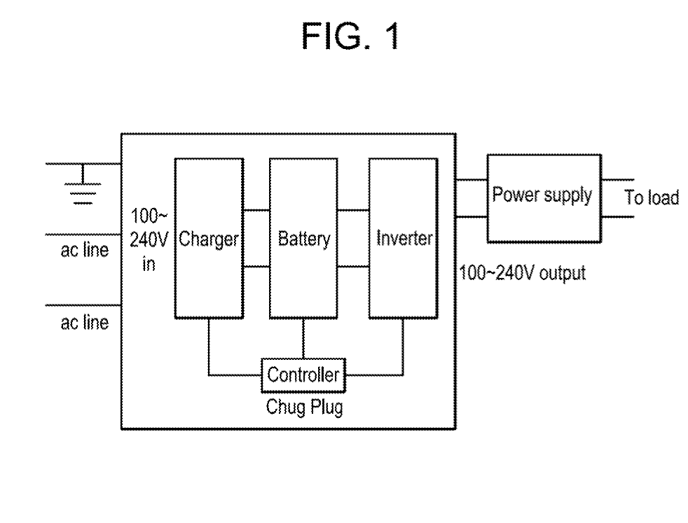

FIG. 1 is a schematic of the invention.

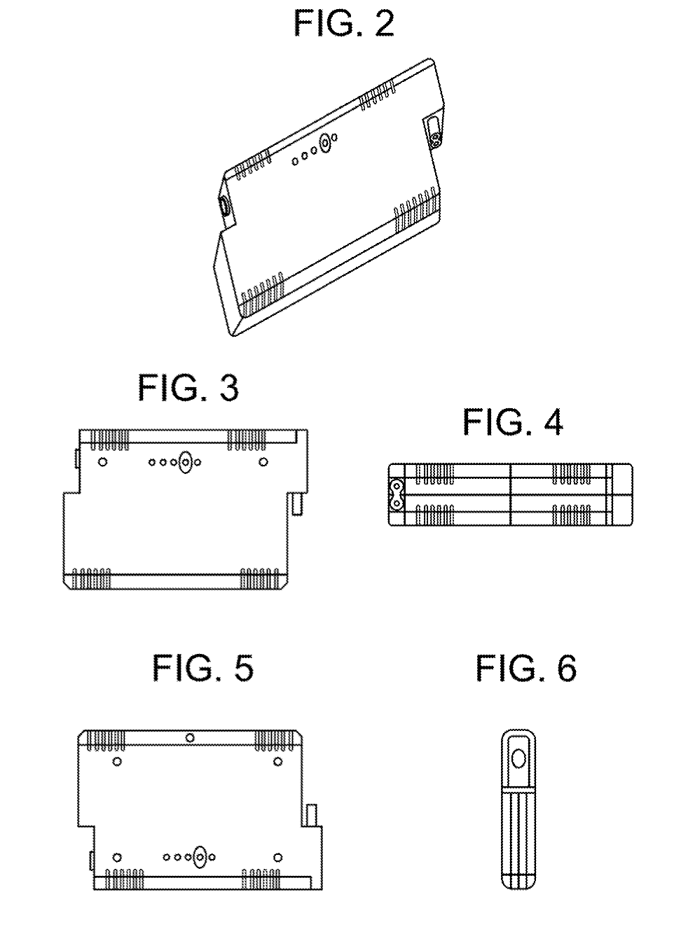

FIG. 2 is a perspective view of the invention.

FIG. 3 is a front elevation view of the invention.

FIG. 4 is a top plan view of the invention.

FIG. 5 is a rear elevation view of the invention.

FIG. 6 is a side elevation view of the invention.

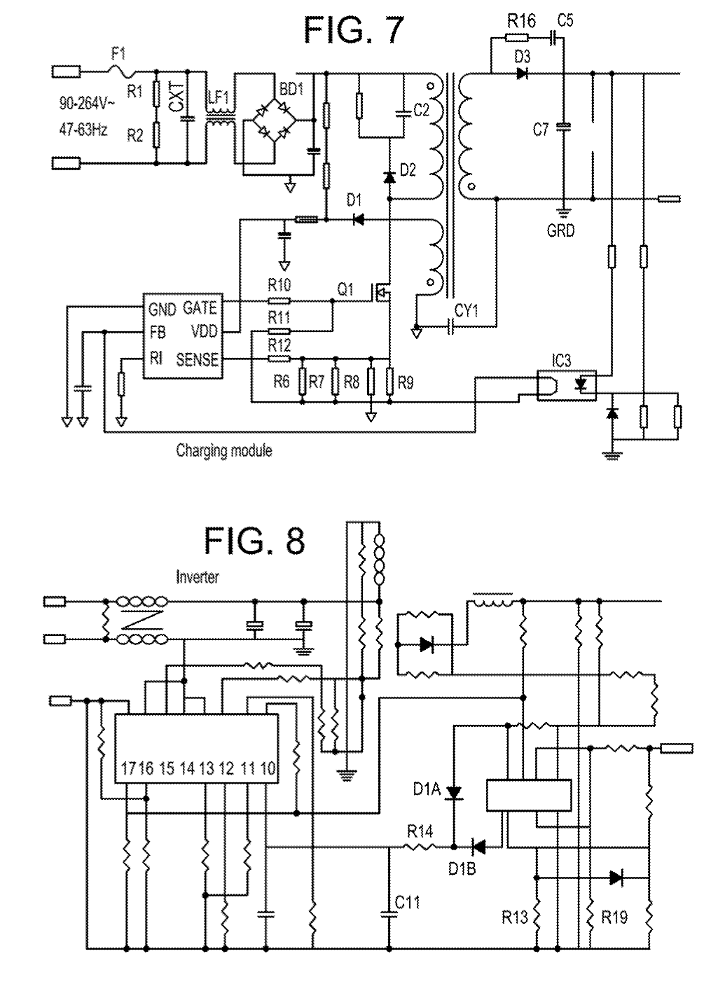

FIG. 7 is a circuit diagram of the charging module.

FIG. 8 is a circuit diagram of the inverter.

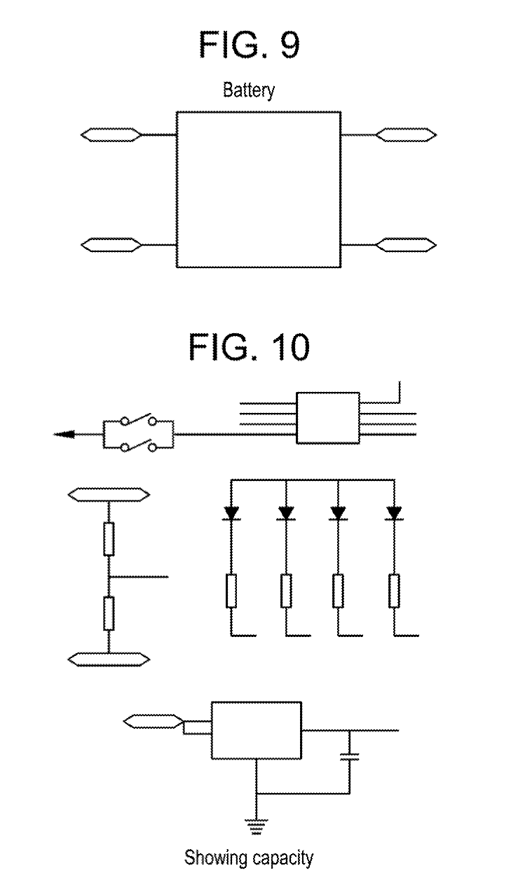

FIG. 9 is a schematic view of the battery.

FIG. 10 is a schematic view of the invention.

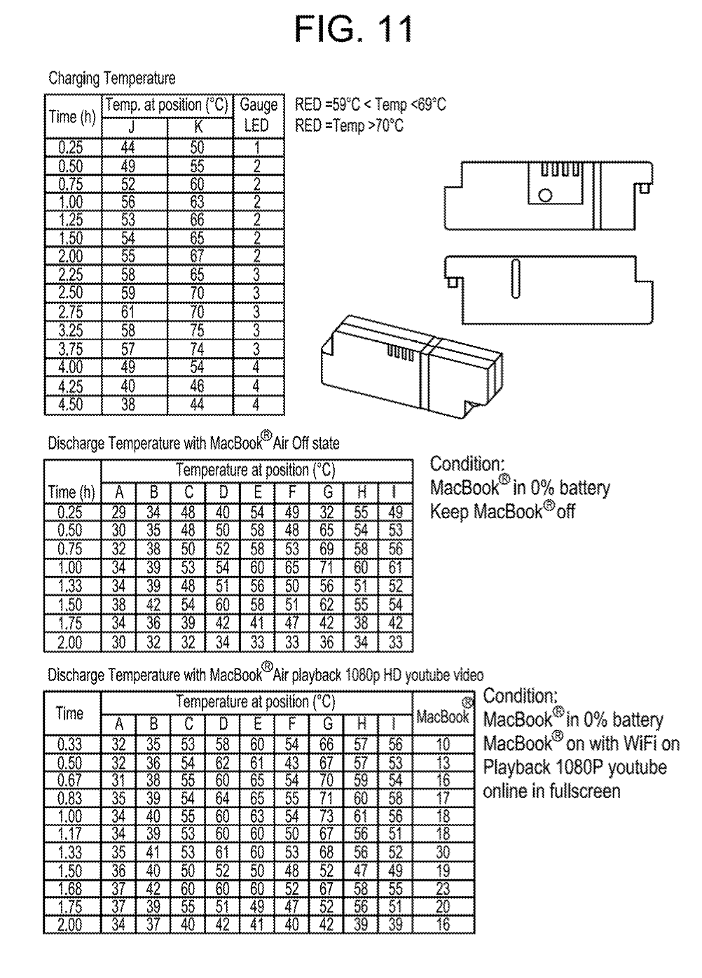

FIG. 11 is a chart showing test results of the invention.

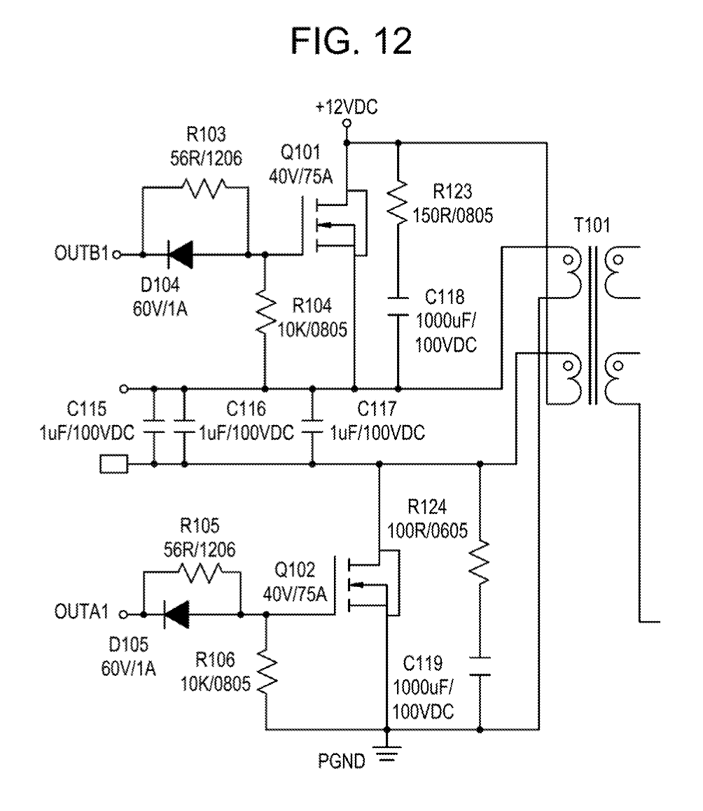

FIG. 12 is a circuit diagram of the invention.

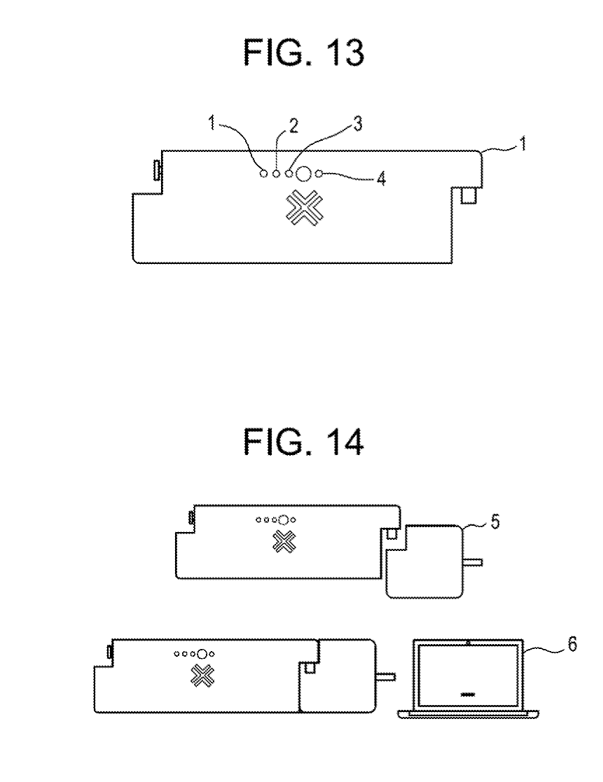

FIG. 13 is front elevation view of the invention.

FIG. 14 is front elevation view of the invention powering a device.

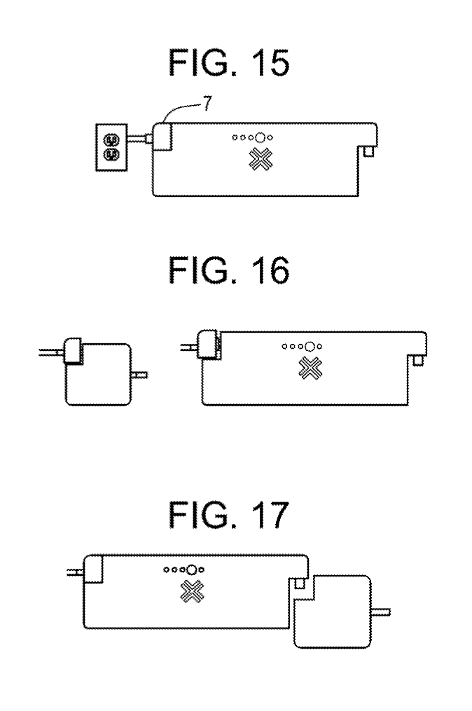

FIG. 15 is front elevation view of the invention charging from grid power.

FIG. 16 is front elevation view of the invention accepting a device power cord.

FIG. 17 is front elevation view of the invention charging from a device power cord and simultaneously powering a device.

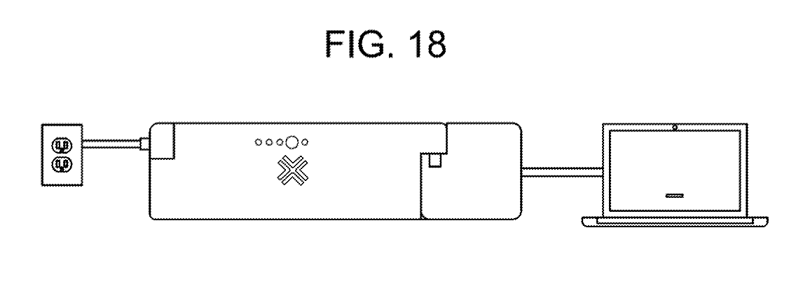

FIG. 18 is front elevation view of the invention charging from a device power cord and simultaneously powering a device.

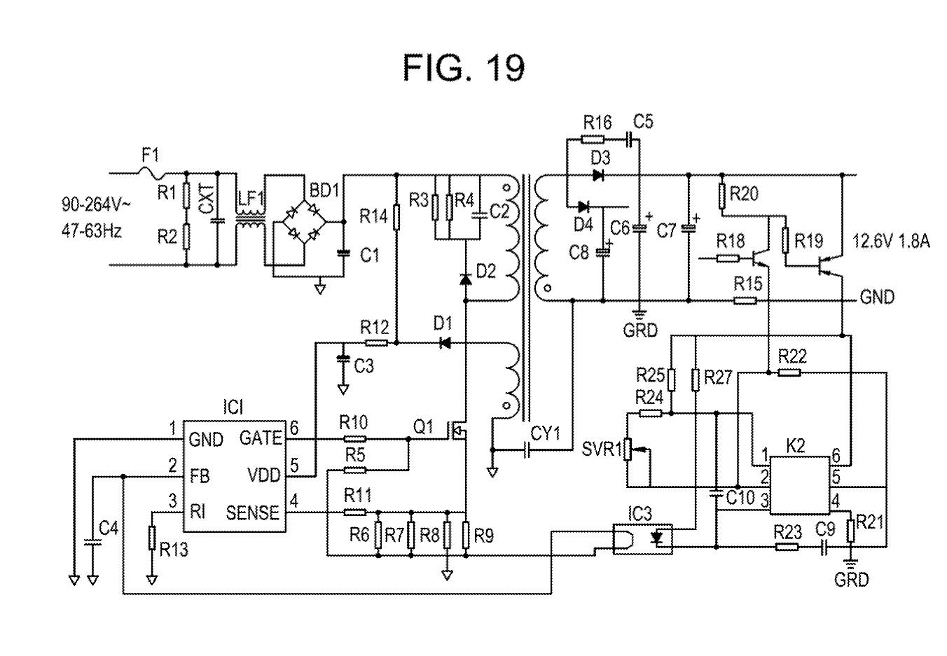

FIG. 19 is a schematic for the charge circuit of the invention.

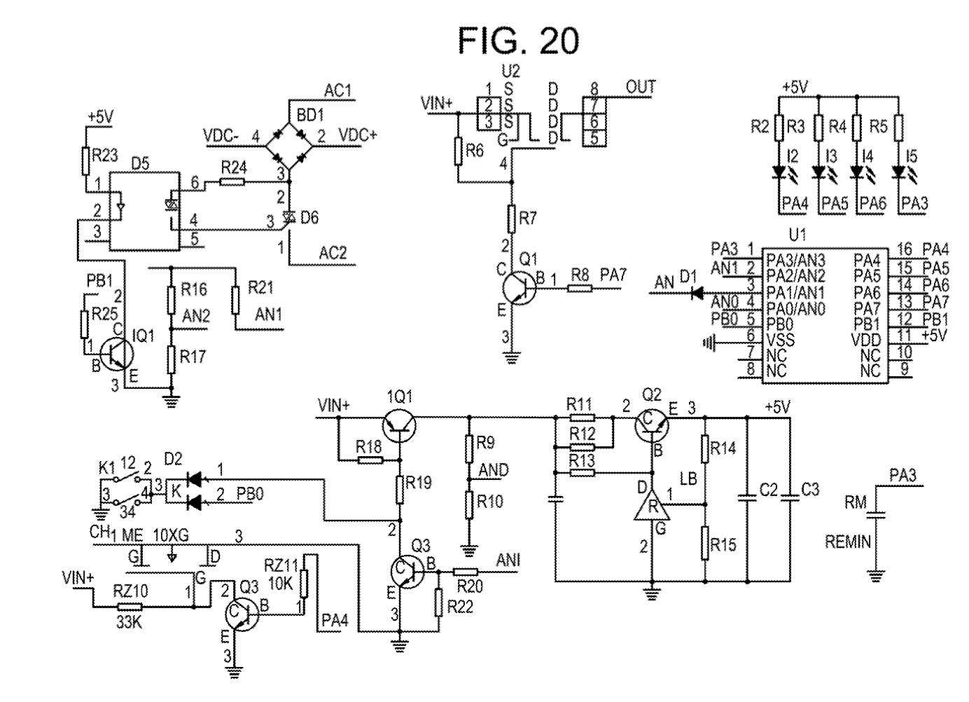

FIG. 20 is a schematic for the control circuit of the invention.

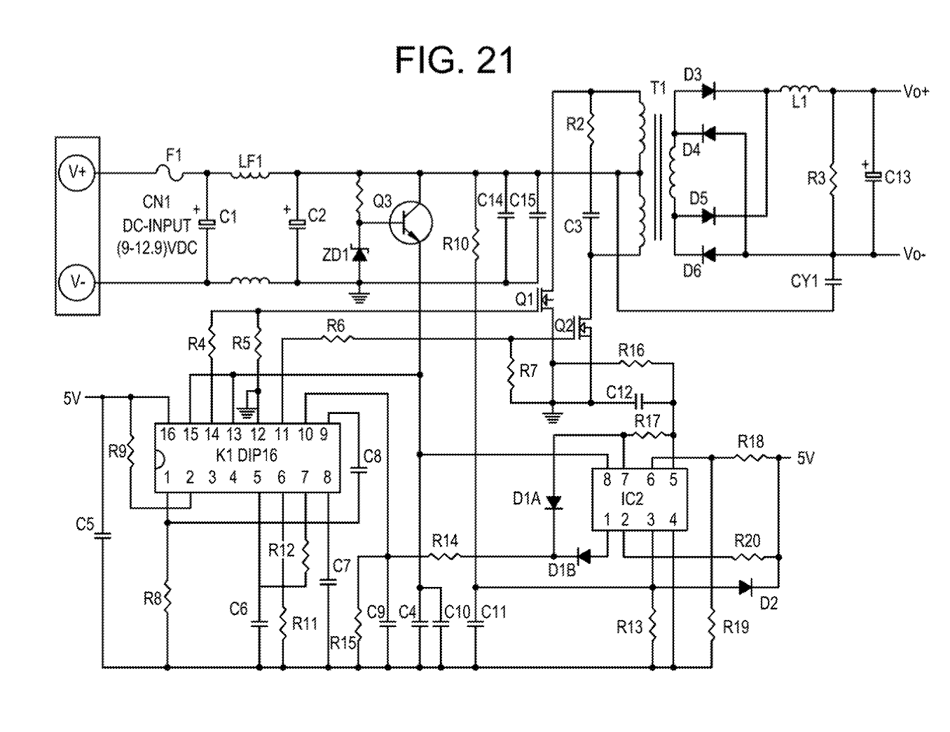

FIG. 21 is a schematic for the inverter circuit of the invention.

### DETAILED DESCRIPTION OF THE INVENTION

The present invention sets out for the first time a portable device which accepts 110 V or 220 V alternating current input on one side of the device, stores the electronic energy in an internal battery, and outputs the stored electronic energy in the form of 110 V or 220 V alternating current.

The device has a convenient shape such that when the input power is connected on one side and the output plug is connected on the other side, the device maintains a generally rectangular shape.

The device is sized to fully charge a variety of different batteries commonly used in portable devices, such as the iPhone®, the iPad®, other tablets, MacBook® or other devices, and other portable computers.

The device circuitry receives 110 V or 220 V alternating current power, and utilizing a microprocessor internally controls and converts the alternating current into direct-current to be stored in an internal battery. A controller controls the distribution of power to an inverter, which changes the direct-current from the battery back into alternating current to be output at 110 V or 220 V.

In operation, the device can be charged by plugging the input into a standard 110 V or 220 V power supply, such as in a building. When the device is charged, it can be removed from the power supply. Thereafter, it can be transported anywhere the user travels. At such time as the user needs to recharge a portable electronic device, the user will plug into the output of the inventive device the so-called power supply from the electronic device, which requires a 110 V or 220 V alternating current input, and which power supply then transforms the alternating current into direct-current to be sent into the electronic device to charge the battery in the electronic device or to power the device. In this manner, the inventive device allows a user to recharge virtually any portable electronic device at any location in the world, as though they had access to the standard power grid.

The inputs to the device can accept virtually any style of plug. Likewise, the output of the device can also accept virtually any style of power supply input leads. In one embodiment, the device accepts the input and output electrical connectors from Apple® devices.

The result is a portable source of AC power contained in a compact device which is transportable anywhere in the world.

The invention (trade name Chug Plug) mobile power for laptop computers such as Macbook Air® and Macbook® consists of a unique mechanical design of input and output that fits to Apple® laptop computers, as well as a battery pack and three novel electrical circuits: inverter circuit, control circuit, and charging circuit.

The mechanical design is illustrated in FIGS. 13-18.

### 1. Mechanical Design and Operation:

LED 1, 2, and 3 will illuminate green when the invention 1 (Chug Plug) is powered “on”. The LEDs will stay lit for 10 seconds after the power button is depressed. To check the remaining capacity of the invention, depress the power button for less than 3 seconds. The green LEDs will illuminate, displaying the remaining battery capacity.

LED 4 will illuminate orange when the invention is connected to an AC power supply and when it is charging a MacBook 6® or other device. This LED will turn off when the invention is out of power or if the AC Power Supply is disconnected. Remove the two-prong adapter tip from the MagSafe® or other Power Adapter. Align the circular metal post on the MagSafe® or other Power adapter with the plastic grooves on the corresponding piece of the invention (the piece with the two plastic barrels pointing down). Connect the invention to the Apple® AC or other adapter by inserting the two plastic barrels of the invention into the similarly shaped receptacle on the Apple® AC or other adapter. Connect the magnetic DC connector to the MacBook® or other device.

To charge the invention or charge the device of the invention and the Apple® or other laptop computer or device simultaneously:

Remove the two-prong adapter tip from the MagSafe® or other Power Adapter.

Attach the Apple® AC or other power cord 7 to the invention.

Align the circular metal post on the MagSafe® or other Power adapter with the plastic grooves on the corresponding piece of the invention (the piece with the two plastic barrels pointing down).

Connect the invention to the MagSafe® or other Power Adapter by inserting the two plastic barrels of the invention into the similarly shaped receptacle on the MagSafe® or other Power Adapter. Connect the magnetic DC connector to the Macbook® or other device.

Plug the Apple® AC or other Power Cord into an AC outlet. The orange LED will illuminate as soon as the invention begins charging and will remain on until the invention is unplugged from the AC power supply and turned off. The remaining LED's will illuminate green as the invention reaches capacity. Once the 3rd LED is illuminated, the invention has finished charging.

### 1. Electrical Design:

The circuitry consists of three parts: charging circuit, control circuit, and inverter circuit. They are illustrated in the figures below. The charging circuit is responsible for charging the invention battery. The inverter circuit functions to provide power to the MagSafe® or other power supply from the invention battery. The control circuit controls the battery charging and discharging as well as providing battery protection.

It is to be noted that another unique design of the invention is that AC power can bypass the invention battery if charging the invention battery and laptop simultaneously is desired.

Following is a list of key components in the circuitry:

| [symbol] | Item no.¹ | Name | Technical data and securement means | Mark(s) of conformity³ |
|---|---|---|---|---|
| 1 | 1 | Plastic Enclosure | V-0, min. thickness min. 1.5 mm, 80° C. | cURus |
| 3 | 2 | Enclosure for AC inlet | V-0, min. thickness min. 2.0 mm, 80° C. | cURus |
| 4 | 3 | Enclosure for DC outlet | V-0, min. thickness min. 1.5 mm, 80° C. | cURus |
| 3 | 4 | AC inlet | See test report 130900598SHA-001. | NR |
| 4 | 5 | DC outlet | See test report 130900598SHA-001. | NR |
| 8 | 6 | PCB | V-0, Min. thickness 1.4 mm, 130° C. | UR |
| | | | V-0, Min. thickness 1.4 mm, 130° C. | UR |
| 8 | 7 | Internal wires | 20 & 22AWG, 105° C., 600 V, VW-1, | cURus |
| | | | double insulated | |
| 8 | 8 | Insulation paper⁴ | Class (130) B | UR |
| 7 | 8a | Not Heat-Shrinkable | Max. 600 V 200° C., VW-1 | cURus |
| | | PTFE Tubing (on pin | | |
| | | of D3 and D5) | | |
| 5 | 9 | Insulation board | Min. thickness 0.4 mm, 130° C., V-0 | UR |
| 8 | 10 | Lithium battery | Max. charging 4.3 Vdc, Complies | UR |
| | | (no show) | with all single-cell tests in UL1642 | |
| 8 | 11 | Battery package | 11.1 V, 4000 mAh/44 Wh | NR |
| [symbol] | 12 | X2 capacitor (CX1) | 0.22 uF 275 V, 17.5*15*9 mm, 100° C. | cURus |
| 6 | | on charge board | | |
| 6 | 13 | Winding of LF1 on | 130° C. | UR |
| | | charge board | | |
| 6 | 14 | Fuse (F1) on | 1.6 A, 250 V | cURus |
| | | charge board | | |
| 6 | 15 | Y1 capacitor (CY1) | 2200 pF, 250 V | cURus |
| | | on charge board | | |
| 5 | 16 | Optical Isolator | Ext. Cr: min. 7.7 mm; DTI: min. | cURus |
| | | (IC2) on charge board | 0.5 mm; Thermal cycling test. | |
| | | | Max. operating temp.: 110° C. | |
| 6 | 17 | Transformer (T1) | Class 130 (B) insulation system, | UR |
| | | on charge board | designated DV-130-1. Details see | |
| | | | illustration No. 6. | |
| 9 | 17a | Insulation tape | 130° C. | UR |
| 15 | 17b | bobbin | V-0, min. thickness 0.75 mm, 150° C. | cURus |
| 12 | 17c | tubing | Max. 150 V 200° C., VW-1 | UR |
| 13 | 17d | primary winding | 130° C. | UR |
| 15 | 17e | secondary winding | 130° C. Class B | UR |
| 8 | 18 | Optical Isolator (D5) | Int Cr: min. 4.8 mm; Ext. Cr: min. | CSA |
| | | on control board | 7.8 mm; DTI: min. 0.45 mm; | |
| | | | having an isolation voltage of | |
| | | | 5000 Vrms; ThermalcyclinQ test. | |
| 7 | 19 | Fuse (F1) on | 15 A, 250 V | cURus |
| | | inverter board | | |
| 7 | 20 | Winding of LF1 on | 130° C. | UR |
| | | inverter board | | |
| 7 | 21 | Y1 capacitor (CY1) | 1000 pF, 250 V, 125° C. | cURus |
| | | on inverter board | | |
| 7 | 22 | Transformer (T1) | Class 130 (B) transformer | UR |
| | | on inverter board | insulation systems, designated | |
| | | | TCE-B. Details see illustration No. 7. | |
| 17 | 22a | Insulation tape | 130° C. | UR |
| 24 | 22b | bobbin | V-0, min. thickness 0.75 mm, 150° C. | cURus |
| 21 | 22c | tubing | Max. 150 V 200° C., VW-1 | UR |
| 20 | 22d | secondary winding | 130° C. | UR |
| 21 | 22e | primary winding | 130° C. | UR |

[symbol]

indicates data missing or illegible when filed

What is claimed is:

1. A portable unitary device for powering an item of portable electronic equipment, comprising:
a charging device having a direct-current battery, said charging device having an alternating current input receptacle and an alternating current output receptacle,
a charging circuit for charging said battery,
an inverter circuit for converting electrical energy from said direct-current battery to alternating current,
a control circuit for controlling the charging level and discharge level of the battery, and also for protecting the battery against overcharging,
a single housing for containing said circuits and said battery and said input and output receptacles,
wherein input alternating current electrical energy is input to said input receptacle, said input alternating current electrical energy is converted by said charging circuit to input direct-current energy, said input direct-current energy is input to said direct-current battery, said battery outputs output direct-current energy to said inverter circuit, and said device outputs output alternating current energy through said alternating current output receptacle to a further device.

2. A unitary device according to claim 1, wherein said alternating current input receptacle accepts and electrically mates with an Apple® alternating current power cord.

3. A unitary device according to claim 1, wherein said alternating current output receptacle accepts and electrically mates with an Apple® MagSafe® power adapter.

4. A unitary device according to claim 1, wherein said alternating current input receptacle accepts and electrically mates with an Apple® alternating current power cord, and said alternating current output receptacle accepts and electrically mates with an Apple® MagSafe® power adapter.

5. A unitary device according to claim 1, further comprising a bypass charging circuit which accepts said input alternating current power converting it to direct-current power to charge said direct-current battery, and simultaneously routes bypass alternating current power to said alternating current output receptacle.

6. A unitary device according to claim 1, wherein said input alternating current electrical energy and said output alternating current electrical energy are 110 volts.

7. A unitary device according to claim 1, wherein said input alternating current electrical energy is 110 volts, and said output alternating current electrical energy is 220 volts.

8. A unitary device according to claim 1, wherein said input alternating current electrical energy is 220 volts and said output alternating current electrical energy is 110 volts.

9. A unitary device according to claim one, wherein said input alternating current electrical energy is 220 volts and said output alternating current electrical energy is 220 volts.
